(19) United States
(12) Patent Application Publication
(10) Pub. No.: US 2010/0053193 A1
(43) Pub. Date: Mar. 4, 2010

(54) DATA CREATING APPARATUS AND DRAWING APPARATUS

(76) Inventors: Takayuki NAGAMATSU, Osaka-shi (JP); Makoto Sakuta, Osaka-shi (JP); Yasuhisa Nakamura, Osaka-shi (JP); Akio Kotani, Osaka-shi (JP); Kayo Okamoto, Osaka-shi (JP)

Correspondence Address: BIRCH STEWART KOLASCH & BIRCH, PO BOX 747, FALLS CHURCH, VA, 22040-0747, US

(21) Appl. No.: 12/549,121

(22) Filed: Aug. 27, 2009

(30) Foreign Application Priority Data
Aug. 28, 2008 (JP) 2008-219620

(51) Int. Cl. G09G 5/02

(52) U.S. Cl. 345/589

(57) ABSTRACT

A data creating apparatus creates image data for causing a graphic to be displayed by a displaying device. In the data creating apparatus, an information acquiring unit acquires information on a display characteristic of the displaying device. A storing unit stores information representing a basic portion of the graphic. A creating unit creates gradation information that is information for correcting gradation data of a portion other than the basic portion of the graphic. The creating unit creates the gradation information based on the information on the display characteristic of the displaying device.

This nonprovisional application is based on Japanese Patent Application No. 2008-219620 filed on Aug. 28, 2008 with the Japan Patent Office, the entire contents of which are hereby incorporated by reference.

### BACKGROUND OF THE INVENTION

1. Field of the Invention

The present invention relates to creating display data of a drawing object, such as a character, and particularly to creating gradation information in a portion near a basic portion of a drawing object, such as a character.

2. Description of the Background Art

Currently, the resolution of displays usually used is coarse compared with macroscopic resolution. Therefore, when a graphic is displayed, its outlines having steps are sometimes visually confirmed. Such a phenomenon is referred to as “aliasing”. As a method of overcoming aliasing, a technique called “anti-aliasing” (also referred to as “anti-alias”) is known. Anti-aliasing is a technique of consecutively changing the density of filling pixels in the vicinity of outlines of a graphic to be displayed on a display to prevent aliasing.

In general, in order to perform accurate anti-aliasing, a graphic is projected on pixels in a lattice, and the area of the graphic is obtained on a pixel-by-pixel basis. Patent Document 1 (Japanese Patent Laying-Open No. 2004-086479) discloses a technique of calculating the areas of pixels that are divided by outlines and creating drawing data based on the areas.

One of anti-aliasing methods is oversampling. In anti-aliasing using oversampling, one pixel is divided into sub-pixels, for example, of 64×64, and the number of sub-pixels covered with a target graphic is counted, thereby approximately deriving the area. Based on the resultant area, an intermediate color is obtained. Shown in FIG. 16 is an example of the pattern (gradation pattern) of an intermediate color in the case where one pixel is divided into sub-pixels of 2×2.

In the example shown in FIG. 16, an intermediate color having five gradations is expressed based on the number of sub-pixels occupied by a graphic. Specifically, gradation expression is such that gradation patterns of 0, 1, 2, 3 and 4 are provided depending on the number of sub-pixels occupied by the graphic of 0, 1, 2, 3 and 4, respectively.

As mentioned above, attempts have conventionally been made to perform drawing of graphics, such as characters, more smoothly, for example, by anti-aliasing using oversampling as shown in FIG. 16.

Note that anti-aliasing has conventionally been performed uniformly regardless of environments for displaying graphics. However, even with the same graphic, its visual effects may vary depending on an environment in which that graphic is displayed.

Accordingly, the situation in which effects of anti-aliasing are not sufficiently obtained has occurred depending on a display environment.

### SUMMARY OF THE INVENTION

The present invention is conceived in view of such circumstances. An object of the invention is to generate image data suited for the environment in which a graphic is displayed upon generating image data that is data for displaying the graphic.

A data creating apparatus of the present invention is a data creating apparatus for creating image data for displaying a graphic on a displaying device. This data creating apparatus includes an information acquiring unit for acquiring information of a display characteristic of the displaying device, a storing unit for storing information representing a basic portion of the graphic, and a creating unit for creating gradation information that is information for correcting gradation data of a portion other than the basic portion of the graphic. In the data creating apparatus, the creating unit creates the gradation information based on the information of the display characteristic of the displaying device.

A drawing apparatus of the present invention is a drawing apparatus for causing the displaying device to display the graphic based on the image data created by the data creating apparatus mentioned above. The drawing apparatus includes a data mixing unit for generating the gradation data by mixing display data of a graphic display color and display data of a background display color based on the gradation information, and a sending unit for sending image data, which contains the gradation data and data for displaying the basic portion of the graphic, to the displaying device.

A data creating method of the present invention is a data creating method executed in a data creating apparatus that creates image data for displaying a graphic on a displaying device and includes a storing unit for storing information representing a basic portion of the graphic. The data creating method includes the steps of acquiring information of a display characteristic of the displaying device, extracting a portion other than the basic portion of the graphic based on the information stored in the storing unit, and creating gradation information that is information for correcting gradation data of the portion other than the basic portion of the graphic based on the information of the display characteristic of the displaying device.

A drawing method of the present invention is a drawing method of displaying the graphic on the displaying device by sending image data created by the data creating method mentioned above to the displaying device. The drawing method includes the steps of generating the gradation data by mixing display data of a graphic display color and display data of a background display color based on the gradation information, and sending image data, which contains the gradation data and data for displaying the basic portion of the graphic, to the displaying device.

A recording medium according to an aspect of the present invention is a recording medium having stored thereon a program for creating data executed in a data creating apparatus that creates image data for displaying a graphic on a displaying device and includes a storing unit for storing information representing a basic portion of the graphic. The program causes the data creating apparatus to execute the steps of acquiring information of a display characteristic of the displaying device, extracting a portion other than the basic portion of the graphic based on information stored in the storing unit, and creating gradation information that is information for correcting gradation data of the portion other than the basic portion of the graphic based on the information of the display characteristic of the displaying device.

A recording medium according to another aspect of the present invention is a recording medium having stored thereon a program for drawing executed for displaying the graphic on the displaying device by sending image data created by the program for creating data mentioned above to the displaying device. The program causes the data creating apparatus to execute the steps of generating the gradation data by mixing display data of a graphic display color and display data of a background display color based on the gradation information, and sending image data, which contains the gradation data and data for displaying the basic portion of the graphic, to the displaying device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a hardware configuration of an information processing system including an information processing device, which is one embodiment of a data creating apparatus and a drawing apparatus of the present invention.

FIG. 2 is a control block diagram according to one embodiment of the data creating apparatus of the invention.

FIG. 3 is a control block diagram according to one embodiment of the drawing apparatus of the invention.

FIGS. 4A and 4B schematically show one example of skeleton data used by the data creating apparatus of FIG. 2.

FIG. 5 is a view illustrating a content of a general anti-aliasing process.

FIG. 6 is a view illustrating a content of correction of gradation data by the data creating apparatus of FIG. 2.

FIG. 7 is a view illustrating a content of correction of gradation data by the data creating apparatus of FIG. 2.

FIG. 8 is a view illustrating a content of correction of gradation data by the data creating apparatus of FIG. 2.

FIG. 9 is a flow chart of a gradation data creating process performed in the data creating apparatus of FIG. 2.

FIG. 10 is a flow chart of a subroutine of a gradation information creating process of FIG. 9.

FIG. 11 is a graph illustrating gamma characteristics of a displaying device.

FIG. 12 is a flow chart of a modification of the gradation information creating process of FIG. 10.

FIGS. 13A to 13D are views illustrating a modification of correction of gradation data by the data creating apparatus of FIG. 2.

FIG. 14 is a flow chart of a modification of the gradation data creating process of FIG. 9.

FIG. 15 is a view illustrating a modification of correction of gradation data in the data creating apparatus of FIG. 2.

FIG. 16 is a view illustrating oversampling, one of anti-aliasing methods.

### DESCRIPTION OF THE PREFERRED EMBODIMENT

An embodiment of a data creating apparatus and a drawing apparatus of the present invention will be described below with reference to the accompanying drawings. Note that, in the following description, the same components are denoted by the same reference characters throughout the drawings, and the detailed description on the components is not repeated if their names and functions are the same.

1. Configuration of Apparatuses

1-1. Hardware Configuration

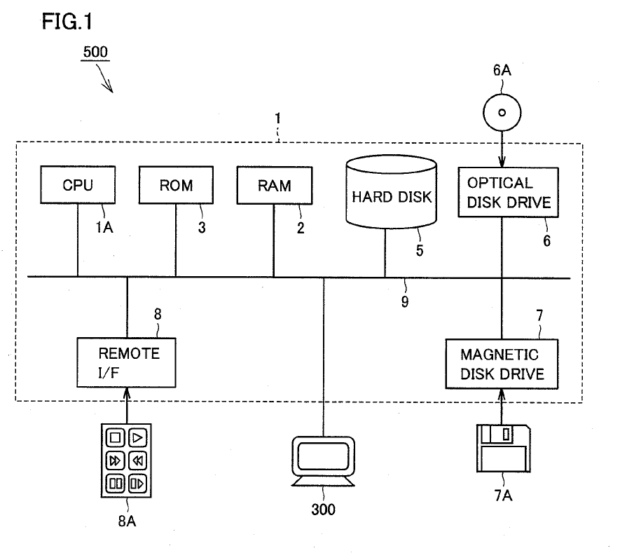

FIG. 1 schematically shows a hardware configuration of an information processing system including an information processing device, or one embodiment of a data creating apparatus and a drawing apparatus of the invention.

With reference to FIG. 1, an information processing system 500 mainly includes an information processing device 1 and a displaying device 300.

Information processing device 1 includes a CPU (Central Processing Unit) 1A for controlling the whole of information processing device 1, a RAM (Random Access Memory) 2 to be a work area of CPU 1A, a ROM (Read Only Memory) 3 for storing programs executed by CPU 1A, and the like, a hard disk 5, an optical disk drive 6, a magnetic disk drive 7, a remote controller (hereinafter referred to as a “remote”) 8A and a remote I/F (interface) 8. In information processing device 1, components are connected through a bus 9.

Optical disk drive 6 and magnetic disk drive 7 can read and/or write information from and/or to an optical disk 6A and a magnetic disk 7A, which are removable from information processing device 1, respectively. A user can input information to information processing device 1 by operating remote 8A. Remote I/F 8 receives information sent from remote 8A and sends the received information to CPU 1A.

Information processing device 1 is connected to displaying device 300. CPU 1A outputs information to be displayed on displaying device 300 to displaying device 300. This allows displaying device 300 to perform displaying based on display data sent from information processing device 1.

1-2. Control Block Configuration of Data Creating Apparatus.

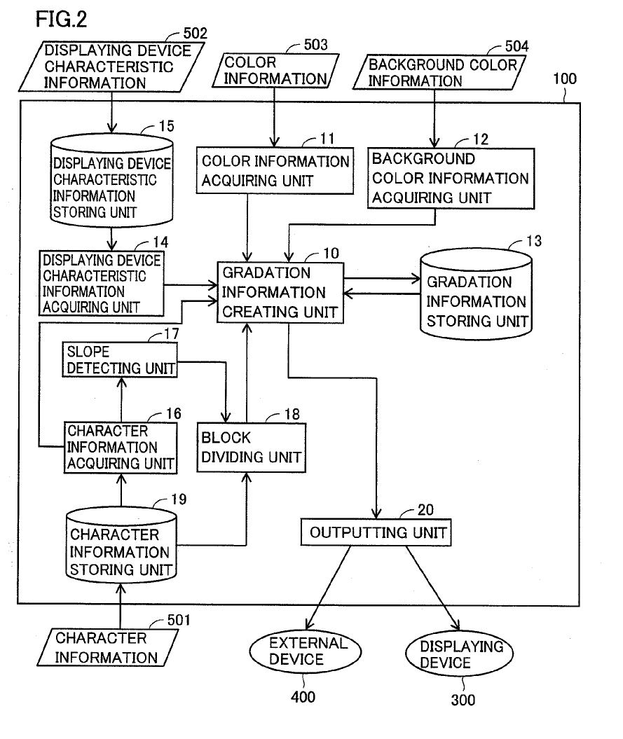

FIG. 2 is a control block diagram in the case where information processing device 1 functions as a data creating apparatus.

With reference to FIG. 2, a data creating apparatus 100 includes a gradation information storing unit 13 for storing gradation information, which is information for correcting gradation data in data subjected to a general anti-aliasing process.

In data creating apparatus 100, when an image including a graphic is displayed by displaying device 300, a gradation information creating unit 10 corrects gradation data of the graphic based on display characteristic information of displaying device 300. Specifically, gradation information creating unit 10 extracts gradation information in accordance with display characteristic information of displaying device 300 from gradation information storing unit 13, and corrects gradation data of data subjected to a general anti-aliasing process by using the extracted gradation information.

The display characteristic information includes displaying device characteristic information 502 including resolution and a gamma characteristic of displaying device 300, color information 503 that specifies a color in which a graphic, such as a character or a symbol, is displayed on displaying device 300 (hereinafter also referred to as a “character color”), and background color information 504 that specifies a color displayed in the background of the graphic.

In data creating apparatus 100, a displaying device characteristic information acquiring unit 14 acquires displaying device characteristic information 502 upon creating display data to be sent to displaying device 300 or upon establishing connection to displaying device 300, and stores the acquired information into a displaying device characteristic information storing unit 15.

Gradation information creating unit 10 acquires color information 503 through a color information acquiring unit 11, and acquires background color information 504 through a background color information acquiring unit 12.

In creating the display data mentioned above, gradation information creating unit 10 acquires displaying device characteristic information 502 and/or color information 503 and background color information 504.

Gradation information creating unit 10 can also acquire character information 501 that specifies the kind of a graphic including a character or a symbol on displaying device 300, and correct display data by using gradation information in accordance with character information 501. In data creating apparatus 100, character information 501 is stored in a character information storing unit 19. Gradation information creating unit 10 acquires character information 501 through a character information acquiring unit 16 when creating display data.

Note that data creating apparatus 100 detects a slope of every portion in each graphic to be displayed by displaying device 300, and the graphic can be divided into two or more blocks by the use of the detected slope. Regarding gradation data of a graphic to be displayed by displaying device 300, gradation information creating unit 10 can correct the gradation data for each block.

Gradation information creating unit 10 sends the gradation data corrected as mentioned above through an outputting unit 20 to displaying device 300. Note that gradation information creating unit 10 can also send the gradation data to another device, such as an external device 400.

Data creating apparatus 100 described above referring to FIG. 2 is implemented with information processing device 1. Specifically, in data creating apparatus 100, gradation information creating unit 10, color information acquiring unit 11, background color information acquiring unit 12, displaying device characteristic information acquiring unit 14, character information acquiring unit 16, a slope detecting unit 17 and a block dividing unit 18 are implemented with CPU 1A for executing programs stored on ROM 3 and/or hard disk 5, and the like. Gradation information storing unit 13, displaying device characteristic information storing unit 15 and a character information storing unit 19 are implemented with RAM 2 and/or hard disk 5.

1-3. Gradation Information

The content of gradation information stored in gradation information storing unit 13 will be described.

The gradation information is information for correcting gradation data in image data as mentioned above. Such information can be represented, for example, in tabular forms.

Correction of gradation data by gradation information creating unit 10 means correcting gradation data of a portion that is a portion near a basic portion of a graphic, such as a character or a symbol, and that is a portion other than the basic portion.

One example of three kinds of gradation information (gradation information 1 to gradation information 3) is shown in Tables 1 to 3.

TABLE 1
GRADATION INFORMATION 1

| | | | | | |
|---|---|---|---|---|---|
| GRADATIONS | 0 | 1 | 2 | 3 | 4 |
| BEFORE | | | | | |
| CORRECTION | | | | | |
| GRADATIONS | 0 | 1 | 1 | 2 | 4 |
| AFTER | | | | | |
| CORRECTION | | | | | |

TABLE 2
GRADATION INFORMATION 2

| | | | | | |
|---|---|---|---|---|---|
| GRADATIONS | 0 | 1 | 2 | 3 | 4 |
| BEFORE | | | | | |
| CORRECTION | | | | | |
| GRADATIONS | 0 | 2 | 3 | 4 | 4 |
| AFTER | | | | | |
| CORRECTION | | | | | |

TABLE 3
GRADATION INFORMATION 3

| | | | | | |
|---|---|---|---|---|---|
| GRADATIONS | 0 | 1 | 2 | 3 | 4 |
| BEFORE | | | | | |
| CORRECTION | | | | | |
| GRADATIONS | 0 | 1 | 2 | 3 | 4 |
| AFTER | | | | | |
| CORRECTION | | | | | |

In gradation information 1 shown in Table 1, if values of gradation data before correction are 0, 1, 2, 3 and 4, they are corrected to be 0, 1, 1, 2 and 4, respectively. Correction by using gradation information 1 shown in Table 1 causes an image of a graphic, such as a character or a symbol, after correction to look slightly thinner. The reason for this is that if the values of gradation data before correction include 2 and 3, the values at the corresponding positions of the gradation data are corrected to be 1 and 2, that is, the densities of displaying are corrected to be lower values.

In gradation information 2 shown in Table 2, if values of gradation data before correction are 0, 1, 2, 3 and 4, they are corrected to be 0, 2, 3, 4 and 4, respectively. In correction by using gradation information 2, if values of gradation data before correction are 1 to 3, they are corrected to 2 to 4 so that each gradation increases by one level. This causes an image of a graphic, such as a character or a symbol, after correction to look slightly thicker.

In gradation information 3 shown in Table 3, gradation data after correction is the same as that before correction.

Note that the number of gradations of gradation data handled in a data creating apparatus of the present embodiment is not limited to five. Gradation information each piece of which corresponds to each of gradation information 1 to gradation information 3 and that is in the case where gradation data is handled in 16 gradations is shown as gradation information 4 to gradation information 6 in Tables 4 to 6, respectively.

In Table 7, an example of gradation information in which, when gradation data is handled in 16 gradations, the values after correction in intermediate gradations are constant is shown as gradation information 7.

TABLE 4
GRADATION INFORMATION 4

| | | | | | | | | | | | | | | | | |
|---|---|---|---|---|---|---|---|---|---|---|---|---|---|---|---|---|
| GRADATIONS | 0 | 1 | 2 | 3 | 4 | 5 | 6 | 7 | 8 | 9 | 10 | 11 | 12 | 13 | 14 | 15 |
| BEFORE | | | | | | | | | | | | | | | | |
| CORRECTION | | | | | | | | | | | | | | | | |
| GRADATIONS | 0 | 0 | 1 | 1 | 2 | 2 | 3 | 4 | 5 | 7 | 8 | 9 | 10 | 11 | 13 | 15 |
| AFTER | | | | | | | | | | | | | | | | |
| CORRECTION | | | | | | | | | | | | | | | | |

TABLE 5
GRADATION INFORMATION 5

| | | | | | | | | | | | | | | | | |
|---|---|---|---|---|---|---|---|---|---|---|---|---|---|---|---|---|
| GRADATIONS | 0 | 1 | 2 | 3 | 4 | 5 | 6 | 7 | 8 | 9 | 10 | 11 | 12 | 13 | 14 | 15 |
| BEFORE | | | | | | | | | | | | | | | | |
| CORRECTION | | | | | | | | | | | | | | | | |
| GRADATIONS | 0 | 1 | 3 | 4 | 6 | 7 | 9 | 11 | 12 | 13 | 13 | 14 | 14 | 14 | 15 | 15 |
| AFTER | | | | | | | | | | | | | | | | |
| CORRECTION | | | | | | | | | | | | | | | | |

TABLE 6
GRADATION INFORMATION 6

| | | | | | | | | | | | | | | | | |
|---|---|---|---|---|---|---|---|---|---|---|---|---|---|---|---|---|
| GRADATIONS | 0 | 1 | 2 | 3 | 4 | 5 | 6 | 7 | 8 | 9 | 10 | 11 | 12 | 13 | 14 | 15 |
| BEFORE | | | | | | | | | | | | | | | | |
| CORRECTION | | | | | | | | | | | | | | | | |
| GRADATIONS | 0 | 1 | 2 | 3 | 4 | 5 | 6 | 7 | 8 | 9 | 10 | 11 | 12 | 13 | 14 | 15 |
| AFTER | | | | | | | | | | | | | | | | |
| CORRECTION | | | | | | | | | | | | | | | | |

TABLE 7
GRADATION INFORMATION 7

| | | | | | | | | | | | | | | | | |
|---|---|---|---|---|---|---|---|---|---|---|---|---|---|---|---|---|
| GRADATIONS | 0 | 1 | 2 | 3 | 4 | 5 | 6 | 7 | 8 | 9 | 10 | 11 | 12 | 13 | 14 | 15 |
| BEFORE | | | | | | | | | | | | | | | | |
| CORRECTION | | | | | | | | | | | | | | | | |
| GRADATIONS | 0 | 1 | 3 | 4 | 5 | 6 | 7 | 7 | 7 | 8 | 9 | 11 | 12 | 13 | 14 | 15 |
| AFTER | | | | | | | | | | | | | | | | |
| CORRECTION | | | | | | | | | | | | | | | | |

1-4. Information Representing Basic Portion of Graphic

In character information storing unit 19, skeleton data (one example of information representing the basic portion of a character or a symbol) for a graphic, such as a character or a symbol, to be displayed by displaying device 300 is stored in association with a code number provided to each of the character or the symbol.

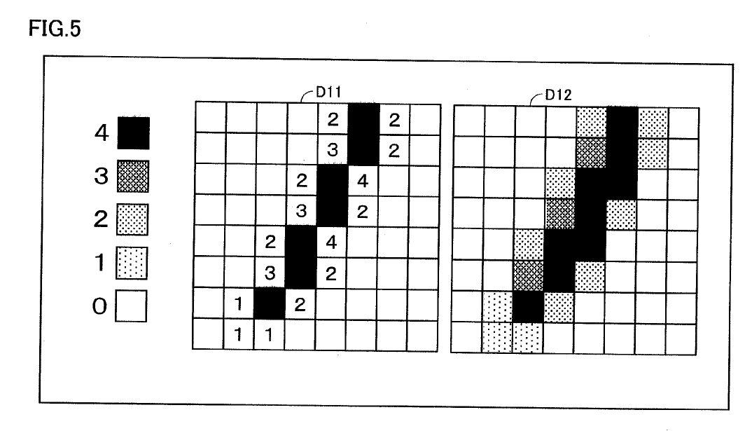

In the present embodiment, as the skeleton data that is one example of information representing the basic portion, coordinates for specifying lines representing skeletons (skeleton lines), or one example of the basic portion of each graphic, are stored as shown in FIG. 4A.

Shown in FIG. 4A is skeleton data of some Chinese character. Specifically, the skeleton lines of the Chinese character are eight strokes from ST1 to ST8 as shown in FIG. 4B. Coordinates that specify the starting point and the end point of each of strokes ST1 to ST8 are stored as terminal points 1 and terminal points 2 in FIG. 4A.

Note that, in the present embodiment, information representing a basic portion of a graphic is not limited to skeleton data, and may be outline data. That is, assuming that outline data is basic portion data, for the outline data or data obtained by subjecting the outline data to an anti-aliasing process, data creating apparatus 100 may correct gradation data of a portion near a basic portion in that data.

1-5. Drawing Apparatus

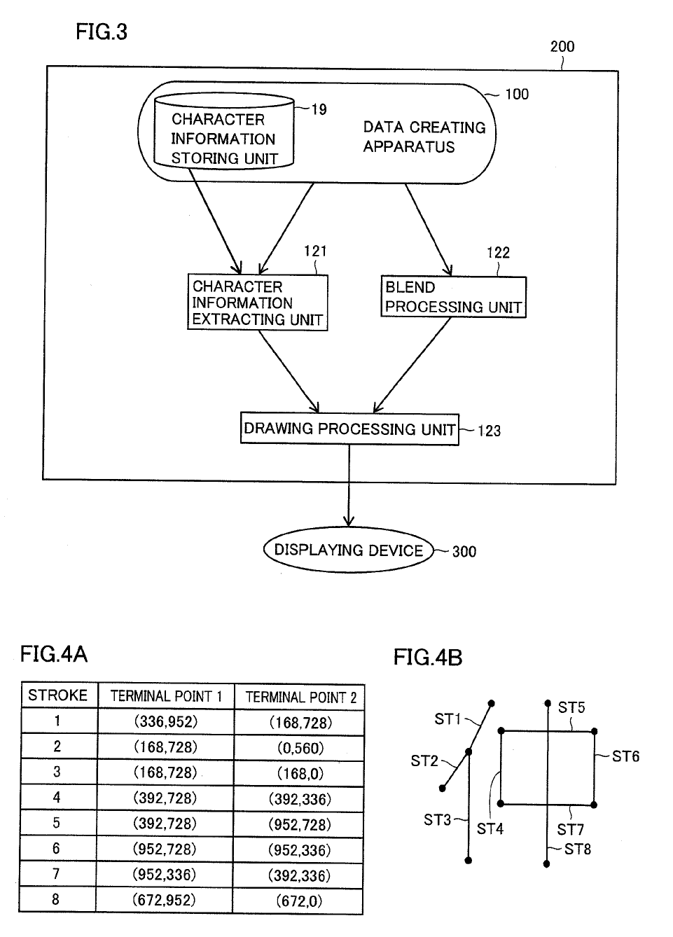

FIG. 3 is a control block diagram in the case where information processing device 1 functions as a drawing apparatus.

A drawing apparatus 200 creates data for displaying by mixing, for example, color data of a character color and color data of a background color based on gradation data created in data creating apparatus 100, and sends the data for displaying to displaying device 300.

With reference to FIG. 3, drawing apparatus 200 includes data creating apparatus 100.

In drawing apparatus 200, a character information extracting unit 121 extracts information, which specifies a basic portion of a graphic to be displayed by displaying device 300, from character information storing unit 19. A blend processing unit 122 mixes the character color and the background color in accordance with gradation data for a portion that is near the basic portion of the graphic displayed by displaying device 300 and that is one other than the basic portion, thereby generating data for displaying of that portion.

Here, the character color is a color specified by color information 503 (see FIG. 2), and the background color is a color specified by background color information 504 (see FIG. 2).

In drawing apparatus 200, a drawing processing unit 123 combines data for displaying of the basic portion of the graphic, such as a character or a symbol, which is acquired from character information extracting unit 121, with data for displaying of the portion near the basic portion acquired from blend processing unit 122 to create data for displaying of the graphic, and sends the created data for displaying to displaying device 300.

Drawing apparatus 200 described above with reference to FIG. 3 is implemented with information processing device 1.

Specifically, character information extracting unit 121, blend processing unit 122 and drawing processing unit 123 are implemented with CPU 1A for executing programs stored in ROM 3 and/or hard disk 5, and the like.

2. Correction of Gradation Data

In data creating apparatus 100 of the present embodiment, gradation data for a portion other than a basic portion of a graphic is corrected using gradation information stored in gradation information storing unit 13. Here, a specific example of correction by using gradation information will be described.

2-1. Basic Anti-Aliasing Process

As a precondition to correction of gradation data in the present embodiment, first, referring to FIG. 5, providing gradation data to a portion near a basic portion of a graphic by the basic anti-aliasing process will be described.

One example of the basic anti-aliasing process is oversampling. Note that, in the present embodiment, a method of the anti-aliasing process is not limited to oversampling, and other methods may be used. In data creating apparatus 100, image data in which gradation data of a nearby portion is generated by another device using a conventional anti-aliasing process may be a subject of processing. Alternatively, prior to a gradation data creating process to be described later, gradation information creating unit 10 may create image data like D11 of FIG. 5 by an anti-aliasing process using a conventional method.

Image data D11 is image data of part of a graphic.

In image data D11, squares filled in black indicate pixels of a basic portion of a graphic. Squares with numerals written therein positioned near the basic portion mean pixels to which gradation data is provided by a conventional anti-aliasing process.

In FIG. 5, image data is shown in five gradations by using gradation data from 0 to 4.

Image data D12 of FIG. 5 schematically shows one example of data for displaying that is created by filling the square of each pixel in the portion near the basic portion at a density corresponding to gradation data of that pixel, which is shown in image data D11.

2-2. Correction for Thinning

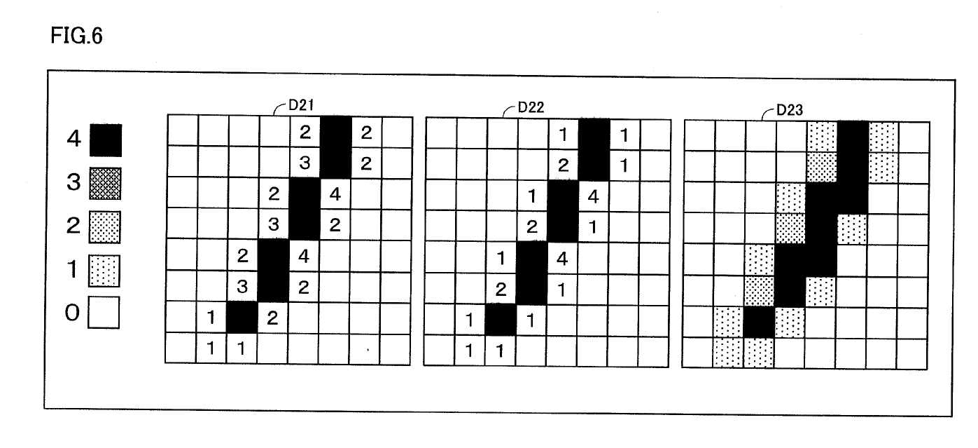

FIG. 6 illustrates correction of gradation data of a portion (hereinafter also referred to as a “nearby portion”) near the basic portion by using gradation information 1 shown in Table 1.

Image data D21 of FIG. 6 shows gradation data provided to the nearby portion by a basic anti-aliasing process, and is the same data as image data D11 of FIG. 5.

Image data D22 of FIG. 6 is image data obtained by correcting gradation data of the nearby portion, which is written in numerals in image data D21 of FIG. 6, by using gradation information 1 of Table 1.

Image data D23 of FIG. 6 schematically shows one example of data for displaying that is created according to gradation data shown in image data D22 of FIG. 6.

Comparing image data D12 of FIG. 5 to image data D23 of FIG. 6, lines of image data D23 as a whole are displayed more thinly than those of image data D12. In other words, it is shown that displayed lines become thinner by correction by using gradation information 1.

Note that such correction is suited for the case of a characteristic where a character looks slightly thicker because of the display characteristic of liquid crystal of displaying device 300 (e.g., the case where the gradation correction causes the characteristic of a background color to be close to the characteristic of a character color) and the case where a combination of a character color and a background color causes a character to look thicker.

2-3. Correction for Thickening

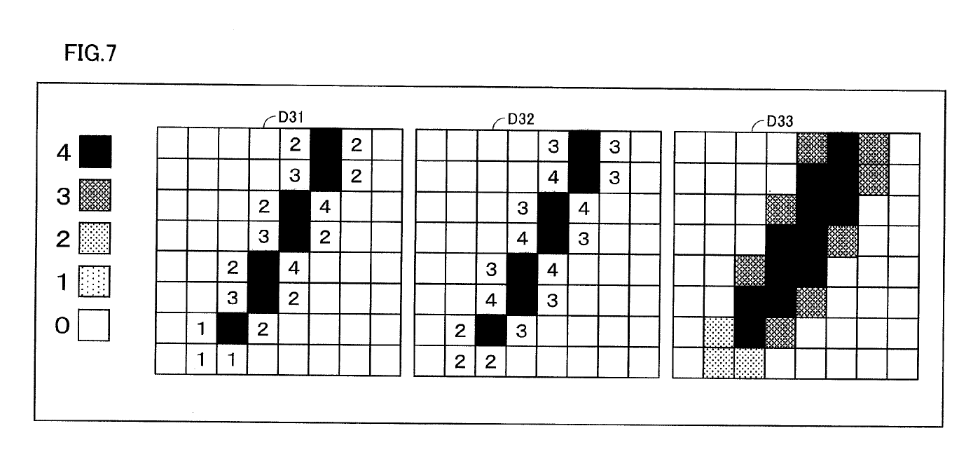

FIG. 7 illustrates correction of gradation data of a portion near a basic portion by using gradation information 2 shown in Table 2.

Image data D31 of FIG. 7 is gradation data provided to the nearby portion by a basic anti-aliasing process, and is the same data as image data D11 of FIG. 5.

Image data D32 of FIG. 7 is image data obtained by correcting gradation data of the nearby portion, which is written in numerals in image data D31 of FIG. 7, by using gradation information 2 of Table 2.

Image data D33 of FIG. 7 schematically shows one example of data for displaying that is created according to gradation data shown in image data D32 of FIG. 7.

Comparing image data D12 of FIG. 5 to image data D33 of FIG. 7, lines of image data D33 of FIG. 7 as a whole are displayed more thickly than those of image data D12 of FIG. 5. In other words, it is shown that displayed lines become thicker by correction by using gradation information 2.

Such correction is suited for the case where a character looks thinner because of the display characteristic of liquid crystal of displaying device 300 (e.g., the case where gradation correction causes the characteristic of a character color to be close to the characteristic of a background color) and the case where a combination of a character color and a background color causes a character to look thinner.

2-4. Correction for Each Block

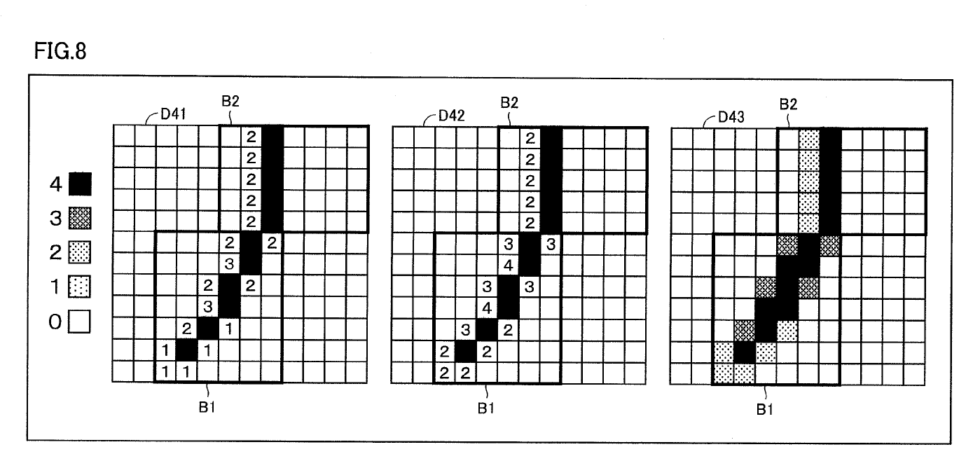

Image data D41 of FIG. 8 is image data in which gradation data is provided to a portion near a basic portion by a basic anti-aliasing process for part of a graphic having a straight line portion and a curve portion. In image data D41 of FIG. 8, squares filled in black indicate pixels of the basic portion of the graphic. Squares with numerals written therein positioned near the basic portion show pixels to which gradation data is provided by a conventional anti-aliasing process.

Note that, in image data D41 of FIG. 8, the straight line portion is indicated by a block B2 and the curve portion is indicated by a block B1. Block division in this way is implemented, for example, by dividing a graphic stroke by stroke in skeleton data described with reference to FIG. 4B.

Image data D42 of FIG. 8 is image data generated by correcting gradation data utilizing gradation information 2 (see Table 2) for block B1, which is a curve portion, and gradation information 3 (see Table 3) for block B2, which is a straight line portion.

Image data D43 of FIG. 8 schematically shows one example of data for displaying that is created according to gradation data shown in image data D42 of FIG. 8.

As described with reference to FIG. 8, when correcting gradation data of a graphic, data creating apparatus 100 divides the graphic into blocks in accordance with slopes of alignments of continuous pixels of the basic portion, and can correct gradation data utilizing different pieces of gradation information for different resultant blocks.

3. Gradation Data Creating Process

Specific processing contents for creating gradation data in data creating apparatus 100 will be described below.

3 -1. Correction of Gradation Data Based on Resolution

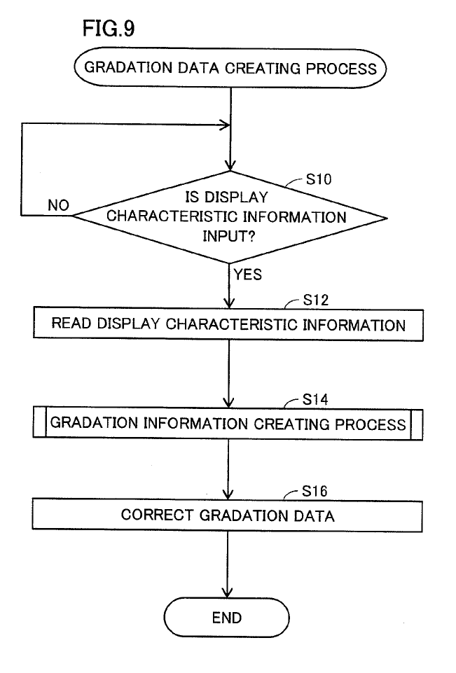

FIG. 9 is a flow chart of a gradation data creating process.

First in step S10, gradation information creating unit 10 determines whether or not display characteristic information is input from displaying device characteristic information acquiring unit 14, color information acquiring unit 11 and/or background color information acquiring unit 12, and the process proceeds to step S12 if the determination is affirmative.

The term “display characteristic information” as used herein is information for determining the kind of gradation information, such as resolution of displaying device 300, for use in correction of gradation data.

In step S12, gradation information creating unit 10 reads display characteristic information, and the process proceeds to step S14.

In step S14, gradation information creating unit 10 performs a process of creating gradation information, which is used for correcting gradation data, and the process proceeds to step S16.

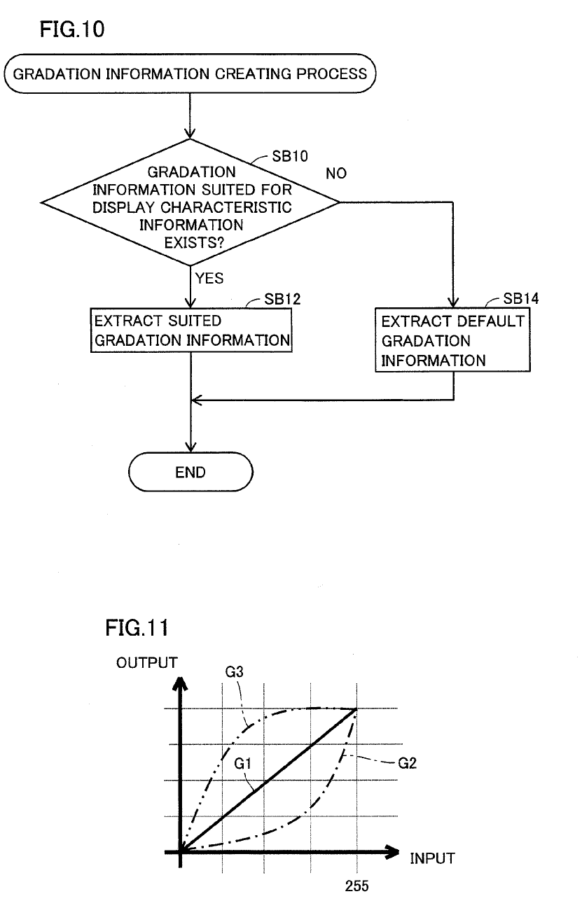

Here, contents of a gradation information creating process performed in step S14 are described with reference to FIG. 10, or a flow chart of a subroutine of the process.

With reference to FIG. 10, in the gradation information creating process, gradation information creating unit 10 first, in step SB10, determines whether or not gradation information suitable for the display characteristic information read in step S12 is stored in gradation information storing unit 13. If the determination for the suited gradation information is affirmative, then the process proceeds to step SB12. If the determination is negative, then the process proceeds to step SB14.

In addition to the gradation information described with reference to Tables 1 to 7, information (optimum gradation information) for associating display characteristic information of displaying device 300 with gradation information suited for the display characteristic information is stored in gradation information storing unit 13. Here, an example of the optimum gradation information is shown.

Table 8 is one example of the optimum gradation information representing image display resolution of displaying device 300 and gradation information suited for each image display resolution.

TABLE 8

RESOLUTION

| | K1 | K2 | K3 | . . . |
|---|---|---|---|---|
| GRADATION | 1 | 1 | 2 | . . . |
| INFORMATION | | | | |

In Table 8, K1, K2 and K3 are exemplified as kinds of image display resolution (hereinafter referred to simply as “resolution”). Here, examples of the resolution include VGA (Video Graphics Array (640×RGB×480 dots)), SVGA (Super Video Graphics Array (800×RGB×600 dots)), XGA (eXtended Graphics Array (1,024×RGB×768 dots)), SXGA (Super eXtended Graphics Array (1,280×RGB×1,024 dots)), SXGA+(Super eXtended Graphics Array+(1,400×RGB×1,050 dots)) and UXGA (Ultra eXtended Graphics Array (1,600×RGB×1,200 dots).

When gradation information for use in correction is determined based on the resolution of displaying device 300 as display characteristic information, gradation information creating unit 10 determines, in step S10, whether or not the resolution of displaying device 300 is stored in displaying device characteristic information storing unit 15 and can be acquired through displaying device characteristic information acquiring unit 14. In step S12, gradation information creating unit 10 extracts the resolution of displaying device 300 from information acquired from displaying device characteristic information acquiring unit 14. Then, in step SB10, referring to optimum gradation information as shown in Table 8, gradation information creating unit 10 determines whether or not there is gradation information in association with the resolution extracted in step S12.

In step SB12, gradation information creating unit 10 extracts gradation information suited for the display characteristic information from gradation information storing unit 13, and the process returns to the flow of FIG. 9.

On the other hand, in step SB14, gradation information creating unit 10 extracts default gradation information, which is stored in gradation information storing unit 13 in advance, and the process returns to the flow of FIG. 9. The default gradation information as used herein is arbitrarily set, and is, for example, gradation information as described with reference to Table 3.

Referring back to FIG. 9, after performing a gradation information creating process in step S14, in step S16, gradation information creating unit 10 corrects gradation data of a portion near a basic portion of a graphic to be displayed on displaying device 300 by using the gradation information extracted in step S14, and then ends the gradation data creating process.

Through the gradation data creating process described above, gradation data of pixels of the portion near the basic portion of the graphic is corrected as described with reference to FIG. 6 and other drawings. That is, in the gradation data creating process, image data processed by a basic anti-aliasing process is a subject of processing. By the gradation data creating process, image data, like image data D21 of FIG. 6, is changed to data with the corrected gradation data of a portion near a basic portion of a graphic, like image data D22 of FIG. 6. Note that gradation information utilized for correction is selected based on display characteristic information.

3-2. Correction of Gradation Data Based on Gamma Characteristic of Displaying Device

In the gradation data creating process of the present embodiment, as described with reference to Table 8, gradation information that is optimum, in accordance with the resolution of displaying device 300 as an example of display characteristic information, is specified in optimum gradation information.

Note that information on a gamma characteristic of displaying device 300 may be employed as another display characteristic information in association with gradation information in optimum gradation information.

Gamma characteristics of displaying device 300 can be classified into three kinds as shown as G1 to G3 in FIG. 11. Shown in FIG. 11 are relationships of actual luminances of fluorescent materials on a displaying device (vertical axis) with respect to luminance signals input to the displaying device (horizontal axis).

In FIG. 11, G1 represents the case where input luminance signals and actual luminances are in a proportional relationship. G2 and G3 each represent the case where they are not in a proportional relationship. Specifically, G2 tends to be concave downward; G3 tends to be concave upward.

In the gradation data creating process, gamma characteristics of displaying device 300 are classified into three tendencies, a tendency of being a linear relationship as indicated by G1, a tendency of being concave downward as indicated by G2 and a tendency of being concave upward as indicated by G3. Optimum gradation information may be set so that the optimum gradation information is specified for each of these tendencies. One example of such optimum gradation information is shown in Table 9.

TABLE 9

| | GAMMA | | |
|---|---|---|---|
| | CHARACTERISTIC | | |
| | TENDENCY | | |
| | G1 | G2 | G3 |
| GRADATION | 3 | 1 | 2 |
| INFORMATION | | | |

Table 9 shows the optimum gradation information associated with each of gamma characteristic tendencies of G1, G2 and G3.

When the gradation data creating process is performed by using such optimum gradation information, in step S10, gradation information creating unit 10 determines whether or not information on a gamma characteristic of displaying device 300 is obtained through displaying device characteristic information acquiring unit 14 from displaying device characteristic information storing unit 15.

In step S12, gradation information creating unit 10 reads the information on the gamma characteristic of displaying device 300, and determines which tendency of G1 to G3 of FIG. 11 that gamma characteristic has.

In step SB10, referring to Table 9, gradation information creating unit 10 determines whether or not there is gradation information corresponding to the gamma characteristic tendency determined in step S12. Then, in step SB12, gradation information creating unit 10 extracts gradation information corresponding to the gamma characteristic tendency determined in step S12.

3-3. Correction of Gradation Data Based on Combination of Character Color and Background Color

In the gradation data creating process of the present embodiment, a combination of a character color and a background color can be employed as display characteristic information. One example of optimum gradation information in such a case is shown in Table 10.

TABLE 10

| | | | | |
|---|---|---|---|---|
| CHARACTER | BLACK | RED | WHITE | . . . |
| COLOR | | | | |
| BACKGROUND | WHITE | WHITE | BLACK | . . . |
| COLOR | | | | |
| GRADATION | 1 | 2 | 3 | . . . |
| INFORMATION | | | | |

Shown in Table 10 is optimum gradation information for each combination of a character color and a background color. When information as shown in Table 10 is utilized as optimum gradation information, in step S10 of the gradation data creating process, gradation information creating unit 10 determines whether or not a character color can be acquired through color information acquiring unit 11 and a background color can be acquired through background color information acquiring unit 12.

In step S12, gradation information creating unit 10 reads information on them.

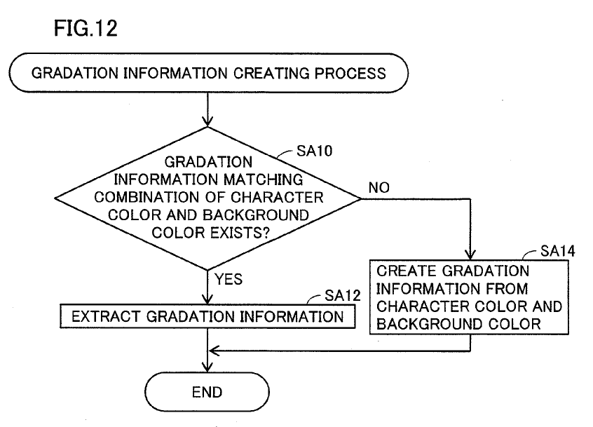

A flow chart of a subroutine of step S14 is shown in FIG. 12.

Referring to FIG. 12, in step SA10, gradation information creating unit 10 determines whether or not gradation information corresponding to the combination of the character color and background color read in step S12 exists in optimum gradation information shown in Table 10. If the determination is affirmative, then the process proceeds to step SA12; if the determination is negative, then the process proceeds to step SA14.

In the determination in step SA10, if the character color and the background color are in such a range that they can be determined to be close to colors defined in Table 10, they can be handled to be the same as those defined in Table 10. Specifically, for example, if each color defined in Table 10 and the character color and background color read in step S12 are represented as values of RGB, and the character color satisfies a relationship represented by expression (1) and the background color satisfies the relationship of expression (1), each of the character color and background color read in step S12 is handled as the same color as that stored in Table 10.

|(R1−R2)*Wr+|(G1−G2)*Wg+|(B1−B2)*Wb<Th (1)

where “*” means multiplication.

In expression (1), R1, G1 and B1 are values of R, G and B of a character color or a background color stored in Table 10, respectively, and R2, G2 and B2 are values of R, G and B of a character color or a background color read in step S12, respectively. Wr, Wg and Wb are weights for R, G and B, respectively, (e.g., each is a third), and Th is a threshold suitably determined.

Referring back to FIG. 12, in step SA12, gradation information creating unit 10 extracts gradation information corresponding to the combination of the character color and background color read in step S12 from Table 10, and the process returns to the flow of FIG. 9.

In step SA14, gradation information creating unit 10 creates gradation information corresponding to the combination of the character color and background color read in step S12, and the process returns to the flow of FIG. 9.

Note that, in step SA14, gradation information creating unit 10 may extract default gradation information, and may extract gradation information in association with a character color and a background color according to a combination having a similarity higher than a predetermined threshold or the highest similarity to the combination of the character color and background color read from Table 10 in step S12.

The similarity as used herein is determined in total consideration of the degree at which character colors are similar to each other and the degree at which background colors are similar to each other. For example, the largest similarity can be defined as the largest sum of a value of expression (2) calculated for character colors and a value of expression (2) calculated for background colors.

1/{|(R1−R2)|*Wra+|(G1−G2)|*Wga+(B1−B2)*Wba} (2)

Note that, in expression (2), R1, G1 and B1 are values of R, G and B of a character color or a background color stored in Table 10, respectively, and R2, G2 and B2 are values of R, G and B of a character color or a background color read in step S12, respectively. Wra, Wga and Wba are weights for R, G and B, respectively, (e.g., each is a third), and Th is a threshold suitably determined.

3-4. Correction in Multiple Levels

As described above, in the present embodiment, a graphic is thickened or thinned by correcting gradation data. Note that, in such correction, finer gradations are formed in gradation data after correction, allowing the increased number of levels of thickening or thinning to be set. This allows the gradation expression to be more detailed in gradation data after correction.

For example, it is conceivable that gradation data expressed in five gradations such as {0/16, 4/16, 8/16, 12/16, 16/16} is corrected in accordance with display characteristic information so that the resultant is data in five gradations divided into ten levels as shown in the following 1) to 10). In this case, each of 1) to 10) corresponds to gradation information, and information for associating display characteristic information with any one of the following 1) to 10) corresponds to optimum gradation information.

1) {0/16, 11/16, 14/16, 15/16, 16/16}

2) {0/16, 11/16, 13/16, 15/16, 16/16}

3) {0/16, 10/16, 13/16, 15/16, 16/16}

4) {0/16, 10/16, 12/16, 14/16, 16/16}

. . .

7) {0/6, 5/16, 9/16, 13/16, 16/16}

. . .

10) {0/16, 2/16, 5/16, 10/16, 16/16}

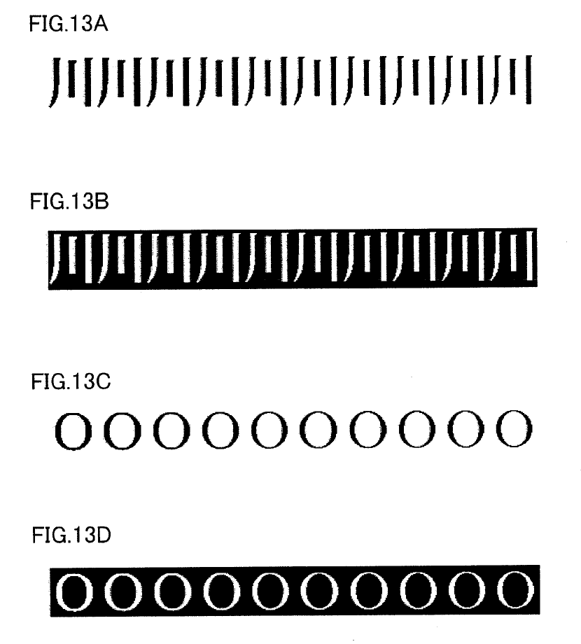

Changes in images displayed based on gradation data after correction in the case of correction in ten levels are shown in FIGS. 13A to 13D.

In each of FIGS. 13A and 13B, ten images of a certain Chinese character are shown. Ten images in each drawing are produced by correcting single gradation data before correction by using each of the gradation information of the above 1) to 10).

In each of FIGS. 13C and 13D, ten images of “O” of the English alphabet are shown. Ten images in each drawing are produced by correcting single gradation data before correction by using each of the gradation information of the above 1) to 10).

In FIGS. 13A and 13C, the character color is “black”, and the background color is “white”.

In FIGS. 13B and 13D, the character color is “white”, and the background color is “black”.

Shown in each of FIGS. 13A to 13D are graphics after correction for making the character thicker as the position of the character moves from right to left, that is, correction for making the character thinner as the position of the character moves from left to right.

As understood from FIGS. 13A to 13D, changing the gradation information for use in correction allows change in visual effects due to the image of a graphic displayed based on gradation data after correction.

3-5. Correction of Gradation Data for Each Block

In the gradation data creating process of the present embodiment, as described with reference to FIG. 8, a graphic is divided into blocks for each slope of its basic portion, and gradation data of a portion near the basic portion can be corrected for each block.

Here, the gradation data creating process in this case is described.

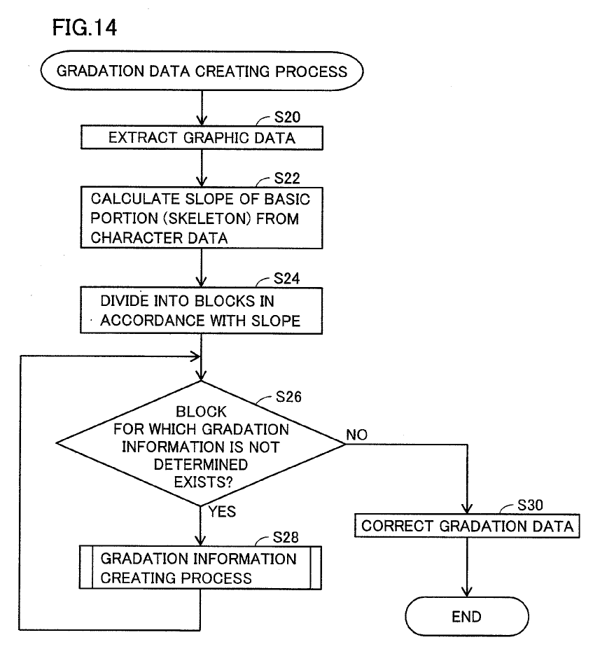

FIG. 14 is a flow chart of a modification of the gradation data creating process.

In the gradation data creating process of this modification, gradation information creating unit 10 first extracts data on a graphic in step S20, calculates the slope of a skeleton portion, or an example of the basic portion, from the graphic data in step S22, and divides the graphic into blocks in accordance with the slope of the skeleton portion in step S24.

Note that, in the process in steps S20 to S24, as described with reference to FIGS. 4B and 8, skeleton data of a graphic to be displayed on displaying device 300 is read, and the graphic may be divided into blocks based on the skeleton data.

Referring back to FIG. 14, next, in step S26, gradation information creating unit 10 determines whether or not a block for which gradation information is not determined exists in all blocks divided in step S24. If the determination is affirmative, then the process proceeds to step S28.

In step S28, a gradation information creating process as described with reference to FIG. 10 is performed for a block that is being processed, and gradation information suited for the block is extracted.

Note that, in the gradation information creating process in this case, gradation information suited for the slope of a skeleton portion in a block that is being processed is extracted instead of extraction of gradation information suited for display characteristic information in step SB10.

The slope of a skeleton portion and gradation information suited for the slope are associated, for example, by using a table as shown in Table 11.

TABLE 11

| | | |
|---|---|---|
| ANGLE OF STROKE | 0° ≦ AN < A × 1 | A × 1 ≦ AN < A × 2 |
| | A × 2 ≦ AN < A × 3 | A × 3 ≦ AN < A × 4 |
| | A × 4 ≦ AN < 180° | |
| GRADATION | 3 | 1 |
| INFORMATION | | |

In Table 11, the angle of a stroke relative to the vertical direction (the slope of a skeleton portion) is associated with gradation information suited for that angle.

Referring back to FIG. 14, in step S28, as mentioned above, the optimum gradation information is extracted for each block by utilizing a table shown in Table 11. In step S26, if it is determined that gradation information has been determined for all blocks, then, in step S30, gradation information creating unit 10 corrects gradation data for all blocks by using gradation information extracted in step S28, and ends the gradation data creating process.

4. Other Modifications

In the gradation information creating process of the present embodiment, gradation information stored in advance in gradation information storing unit 13 is extracted based on display characteristic information and the like. Note that in data creating apparatus 100, information equivalent to the gradation information as described with reference to Tables 1 to 7 may be created each time the gradation information creating process is performed, without storing the gradation information as described with reference to Tables 1 to 7 in advance.

In the present embodiment, the gradation information is represented in a tabular form in which gradation data before correction and gradation data after correction are associated with each other. However, the form of gradation information is not limited to such a form. The gradation information may be stored in a transformation or the like into hard disk 5 as long as the form enables gradation data before correction to be transformed in the same manner as in the present embodiment into gradation data after correction.

In the gradation information creating process of the present embodiment, gradation information used for correction of gradation data may be selected in accordance with the kind of graphics, such as a character and a symbol. For example, graphics displayed on displaying device 300 are divided into characters (e.g., “C”) and symbols (e.g., “@”) with a higher proportion of curves, and characters (e.g., “H”) and symbols (e.g., “[”) with a higher proportion of straight lines. Regarding the former graphics, gradation data may be corrected by using gradation information 1 or gradation information 2; regarding the latter graphics, gradation data may be corrected using gradation information 3 (or gradation data may not be corrected).

In correction of gradation data in the gradation information creating process of the present embodiment, the mode of correction may be changed in accordance with the number of pixels of skeleton portions adjacent to a pixel of a portion adjacent to a skeleton, in addition to display characteristic information. That is, gradation values may be changed in accordance with positions (as well as numbers) of colored sub-pixels by oversampling.

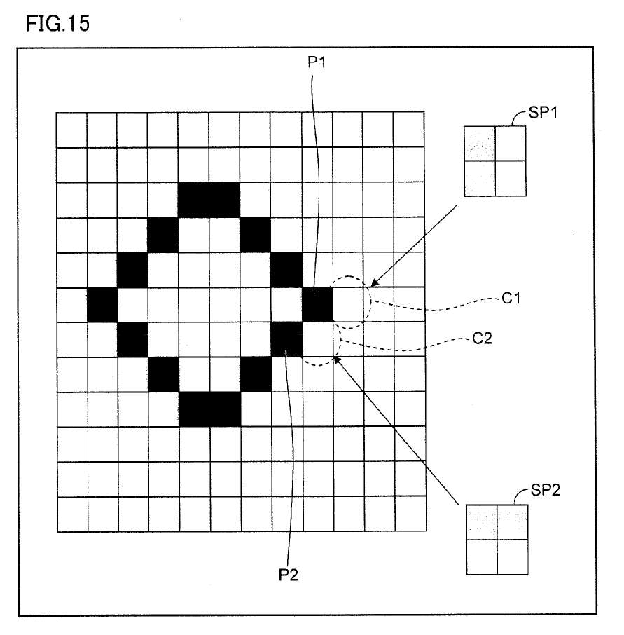

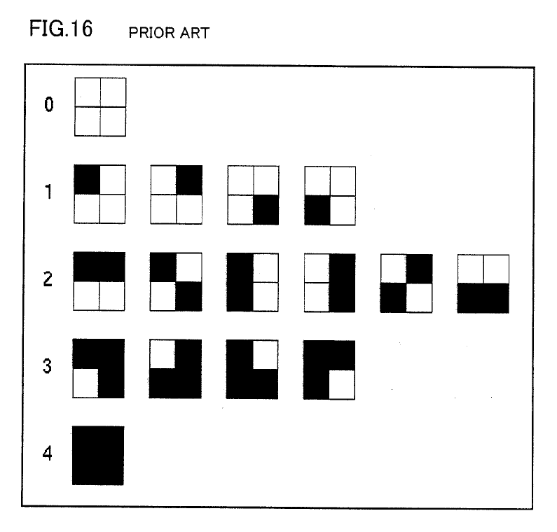

For example, in FIG. 15, in a pixel C1 and a pixel C2 that are adjacent to a pixel P1, or one of skeleton portions, two of four sub-pixels are colored, as shown as SP1 and SP2 in FIG. 15. Note that pixel C2 is also adjacent to a pixel P2, or another skeleton portion. In such a case, it is conceivable that displaying pixel C2 with a higher density than that of pixel C1 allows an image displayed in FIG. 15 to look smoother.

From this, gradation data of pixel C2 may be corrected to have a larger value than gradation data of pixel C1.

5. Drawing Process by Drawing Apparatus

As mentioned above, drawing apparatus 200 creates data for displaying, for example, by mixing color data of a character color with color data of a background color based on gradation data created by data creating apparatus 100, and sends the data for displaying to displaying device 300.

Here, blend processing unit 122 stores, for example, information of associating gradation data with a mixing rate of color data of a character color and color data of a background color.

Specifically, in the case of five gradations, the rates of [color data of a character color]/[color data of a background color] can be set to be 0/4, 1/4, 2/4, 3/4 and 4/4 for five gradations of 0 to 4, respectively.

According to an embodiment of the present invention, gradation data of a portion other than a basic portion of a graphic is corrected based on display characteristic information of a displaying device.

Thus, in creating image data, or data for displaying a graphic, image data suited for the environment for displaying an image can be generated.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A data creating apparatus for creating image data for displaying a graphic on a displaying device, comprising:
an information acquiring unit for acquiring information of a display characteristic of said displaying device;
a storing unit for storing information representing a basic portion of said graphic; and
a creating unit for creating gradation information that is information for correcting gradation data of a portion other than the basic portion of said graphic,
wherein said creating unit creates said gradation information based on the information of said display characteristic of said displaying device.

2. The data creating apparatus according to claim 1, wherein said gradation information is information representing a rate of mixing a color in which said displaying device displays said graphic and a color in which said display device displays a background.

3. The data creating apparatus according to claim 2, wherein said gradation information is information representing the rate of mixing the color in which said displaying device displays said graphic and the color in which said display device displays the background, for each display pixel, for each single or each plurality of sub-pixels of said display pixel, or for each virtual display pixel obtained by virtually multiplying said display pixel a plurality of times in a predetermined direction, for said displaying device.

4. The data creating apparatus according to claim 1, further comprising a dividing unit for dividing said graphic into a block for every slope of the basic portion of the graphic based on information representing the basic portion of said graphic; and
wherein said creating unit creates said gradation information for every block of said graphic.

5. The data creating apparatus according to claim 4, further comprising a storing unit for storing said gradation information in association with the slope of the basic portion of the graphic; and
wherein said creating unit extracts said gradation information from said storing unit for every block of said graphic.

6. The data creating apparatus according to claim 1, wherein
the information of the display characteristic of said displaying device contains a graphic display color and a background display color; and
said creating unit creates said gradation information based on a combination of said graphic display color and said background display color.

7. The data creating apparatus according to claim 6, further comprising a storing unit for storing said gradation information in association with the combination of the graphic display color and the background display color; and
wherein said creating unit extracts said gradation information from said storing unit, said gradation information being stored in association with the combination of said graphic display color and said background display color acquired by said information acquiring unit, among combinations with which said gradation information is stored in said storing unit.

8. The data creating apparatus according to claim 7, wherein said creating unit extracts said gradation information from said storing unit, said gradation information being stored in association with a combination having a similarity higher than a predetermined threshold to the combination of said graphic display color and said background display color acquired by said information acquiring unit, among the combinations with which said gradation information is stored in said storing unit.

9. The data creating apparatus according to claim 7, further comprising a kind acquiring unit for acquiring a kind of a graphic to be displayed on said displaying device; and wherein
said storing unit stores said gradation information in association with the kind of the graphic, and
said creating unit extracts said gradation information in association with the kind of the graphic acquired by said kind acquiring unit.

10. A drawing apparatus for causing said displaying device to display said graphic based on the image data created by the data creating apparatus according to claim 1, the drawing apparatus comprising:
a data mixing unit for generating said gradation data by mixing display data of a graphic display color and display data of a background display color based on said gradation information; and
a sending unit for sending image data to said displaying device, the image data containing said gradation data and data for displaying the basic portion of said graphic.

11. A data creating method executed in a data creating apparatus that creates image data for displaying a graphic on a displaying device and includes a storing unit for storing information representing a basic portion of said graphic, the data creating method comprising the steps of:
acquiring information of a display characteristic of said displaying device;
extracting a portion other than the basic portion of said graphic based on the information stored in said storing unit; and
creating gradation information that is information for correcting gradation data of the portion other than the basic portion of said graphic based on the information of said display characteristic of said displaying device.

12. A drawing method of displaying said graphic on said displaying device by sending image data created by the data creating method according to claim 11 to said displaying device, the drawing method comprising the steps of:
generating said gradation data by mixing display data of a graphic display color and display data of a background display color based on said gradation information; and
sending image data to said displaying device, the image data containing said gradation data and data for displaying the basic portion of said graphic.

13. A recording medium having stored thereon a program for creating data executed in a data creating apparatus that creates image data for displaying a graphic on a displaying device and includes a storing unit for storing information representing a basic portion of said graphic,
said program causing
said data creating apparatus to execute the steps of
acquiring information of a display characteristic of said displaying device;
extracting a portion other than the basic portion of said graphic based on information stored in said storing unit, and
creating gradation information that is information for correcting gradation data of the portion other than the basic portion of said graphic based on the information of said display characteristic of said displaying device.

14. A recording medium having stored thereon a program for drawing executed for displaying said graphic on said displaying device by sending image data created by the program for creating data according to claim 13 to said displaying device,
said program causing
said data creating apparatus to execute the steps of:
generating said gradation data by mixing display data of a graphic display color and display data of a background display color based on said gradation information; and
sending image data to said displaying device, the image data containing said gradation data and data for displaying the basic portion of said graphic.
